(19) United States
(12) Patent Application Publication
(10) Pub. No.: US 2008/0247630 A1
(43) Pub. Date: Oct. 9, 2008

(54) Defect inspecting apparatus and defect-inspecting method

(75) Inventor: Kazuhito Horiuchi, Kamiina-gun (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/999,358

(22) Filed: Dec. 5, 2007

(30) Foreign Application Priority Data
Dec. 8, 2006 (JP) P2006-331770

(51) Int. Cl. G06K 9/78

(52) U.S. Cl. 382/141

(57) ABSTRACT

An image pickup section 3 picks up an inspection object and produces captured image information. An image acquisition section 4 produces an image of the inspection object based on the picked-up image information. A defect-extracting section 5 using the produced image extracts defects on the inspection object. A defects inspection section 6 upon inspecting the extracted defects produces inspection outcomes based on inspection conditions. A substrate inspection-result-producing section 10 upon weighing the inspection result obtained based on the defect-related information and each inspection condition integrates the inspection results obtained based on the inspection conditions. This provides a defect inspection apparatus and defect inspection method that can facilitate a quality check of the substrate and improve throughput of a manufacturing procedure.

### BACKGROUND OF THE INVENTION

1. Field of the Invention

The present invention relates to a defect-inspecting apparatus and defect-inspecting method for inspecting defects on a substrate used in flat panel displays (FPDs) including liquid crystal displays (LCDs) and plasma display panels (PDPs) or a semi-conductor wafer.

The present application is based on patent application No. 2006-331770 filed Dec. 8, 2006 in Japan, the content of which is incorporated herein by reference.

2. Background Art

An inspection apparatus for inspecting aforementioned substrates under various inspection conditions outputs inspection results per inspection condition including the existence of defects; feature information of defects (position or area, etc.); or quality check outcome associated with a predetermined area (e.g., a semi-conductor chip or FPD panel). Each inspection condition has its own advantage, e.g., dark field image observation facilitates detecting of defects such as a scratch; and bright field image observation facilitates the recognition of an exposed abnormal pattern, e.g., delamination (peeling) pattern.

However, what is important to the inspection conducted in the production processes is to establish a method regarding how to understand a plurality of inspection results to obtain a final inspection result since quality check outcomes and root causes per substrate are required. Patent Document 1 discloses introducing a ray emitted from a light source onto a surface of an inspection object; inspecting the inspection object by means of two different inspection tools, having different inspection capability, using light scattered on the surface; and synthesizing the inspection results.

Patent document 1: Japanese Unexamined Patent Application, First Publication No. H10-106941

An inspection apparatus outputs inspection results separately per aforementioned various inspection condition of the production process. Sometimes, an operator may be confused in making decision associated with quality check of the inspection object due to ambiguous criteria therefor. Possibly, such confusion may result in lower throughput in the production process.

To address this, it is important to establish a method of integrating inspection results per inspection condition to achieve a more facile quality check by integrating inspection results. The technique disclosed in Patent Document 1 does not facilitate quality check immediately since inspection results obtained based on two inspection conditions are integrated to enlarge dynamic range of the intensity of light scattered from a foreign body.

The present invention was conceived in consideration of the aforementioned circumstance, and an object thereof is to provide a defect-inspecting apparatus and a defect-inspecting method capable of facilitating quality check of a substrate and improving throughput in all production processes.

### SUMMARY OF THE INVENTION

The present invention conceived to solve the aforementioned problems relates to a defect-inspecting apparatus for inspecting defects on an inspection object based on a plurality of inspection conditions. The apparatus includes: an image-pickup unit for picking up an image of the inspection object and producing image-pickup information; an image-producing unit for producing an image of the inspection object based on the image-pickup information; a defect-extracting unit using the produced image for extracting the defects on the inspection object; a defect-inspecting unit for inspecting the extracted defects and producing inspection results each corresponding to the inspection conditions; and an inspection result integrating unit weighing the inspection result obtained based on the defect-related information and each inspection condition and integrating each of the inspection results obtained based on the inspection conditions.

In addition, the present invention relates to a defect-inspecting method for inspecting defects on an inspection object based on a plurality of inspection conditions. The method includes: picking up an image of the inspection object and producing image-pickup information; producing an image of the inspection object based on the image-pickup information; using the produced image and extracting the defects on the inspection object; inspecting the extracted defects and producing inspection results each corresponding to the inspection conditions; and weighing the inspection result obtained based on the defect-related information and each inspection condition and integrating each of the inspection results obtained based on the inspection conditions.

The present invention integrating a plurality of inspection results associated with an inspection object obtained based on different inspection conditions negates the need for making separate references to a plurality of inspection results for conducting quality check on the inspection object. Also, the inspection results obtained based on various inspection conditions allows priority of each inspection result to be updated on the integrated inspection results. This facilitates quality check of inspection objects, thereby resulting in enhancing throughputs of the whole production process.

### BRIEF DESCRIPTION OF DRAWINGS

FIG. 1 is a block diagram showing the configuration of an inspection apparatus according to an embodiment of the present invention.

FIG. 2 is a flowchart showing the sequential movement of the inspection apparatus according to the embodiment of the present invention.

FIGS. 3A to 3D show details of inspection condition information and information associated with a substrate under inspection (hereinafter called inspected substrate information) according to the embodiment of the present invention.

FIG. 4 is a block diagram showing the configuration of an image-pickup section and an image-obtaining section which are provided to the inspection apparatus according to the embodiment of the present invention.

FIGS. 5A to 5C show details of images obtained by observing the inspection object substrate in the embodiment according to the present invention.

FIG. 6 shows defects on an inspection object substrate in the embodiment of the present invention.

FIGS. 7A to 7C show a correlation between the surface of the inspection object substrate and image pickup sensor in the embodiment of the present invention.

FIGS. 8A to 8C show how the inspection object substrate is rotated in the embodiment according to the present invention.

FIGS. 9A to 9C show details of image resolution conversion in the embodiment according to the present invention.

FIGS. 10A to 10C show how to extract defects in the embodiment according to the present invention.

FIGS. 11A and 11B show details of defect classification information in the embodiment according to the present invention.

FIGS. 12A to 12C show classification names and the corresponding IDs for identifying the class in the embodiment according to the present invention.

FIG. 13 is a flowchart showing the sequential movement of a substrate inspection-result-producing section 10 provided to the inspection apparatus of the embodiment of the present invention.

FIGS. 14A and 14B show details of integrating the inspection results in the embodiment according to the present invention.

FIG. 15 is a flowchart showing a sequence of operations (modified example) carried out by a substrate inspection-result-producing section 10 provided to the inspection apparatus of the embodiment of the present invention.

### PREFERRED EMBODIMENTS

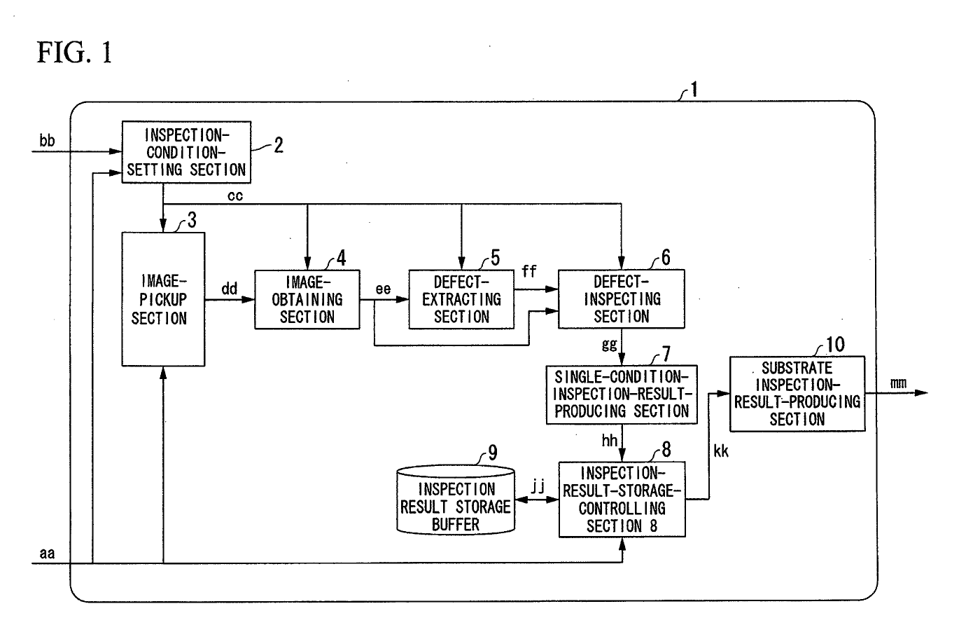

An embodiment of the present invention will be explained below with reference to the drawings. The present embodiment relates to a macro inspection apparatus for semiconductor wafer adapted to the present invention. FIG. 1 is a schematic diagram of an inspection apparatus according to the present embodiment. An inspection apparatus 1 receives externally inputted information including control information aa for controlling the apparatus; and substrate information bb indicating information associated with an inspection object substrate (inspection object) such as design information indicating the substrate type, process, and size and position of a chip and shot, etc. Furthermore, information output from the inspection apparatus 1 is inspection-result information mm associated with the inspection object substrate.

The control information aa and the substrate information bb upon being put into the inspection apparatus 1 are first received by an inspection-condition-setting section 2. The inspection-condition-setting section 2 designates methods for observing a substrate, obtaining images, and extracting defects based on information indicating details of the inspection object substrate and inspection type included in the substrate information bb. Furthermore, the inspection-condition-setting section 2 outputs inspection condition information cc for separate control based on the inspection conditions in each component.

An image-pickup section 3 picks up an image of the inspection object substrate. The image-pickup section 3 upon accepting the control information aa and the inspection condition information cc controls circuits, etc. thereinside based on an image-pickup method designated by the inspection condition information cc and picks up the image of the substrate under various image-pickup conditions. The resulting picked-up images output therefrom become image-pickup information dd. The configuration inside of the image-pickup section 3 will be explained later.

The process carried out by an image-obtaining section 4 includes producing and obtaining an image of an inspection object substrate. The image-obtaining section 4 upon accepting the inspection condition information cc and the image-pickup information dd converts the image-pickup information dd to a two-dimensional image susceptible to image-processing inspection based on image resolution designated by the inspection condition information cc. The converted two-dimensional image output therefrom becomes inspection image information ee. The configuration inside of the image-obtaining section 4 will be explained later.

A process carried out by a defect-extracting section 5 is to extract defects existing on the inspection object substrate by using the produced two-dimensional image. The defect-extracting section 5 upon accepting the inspection condition information cc and the inspection image information ee extracts defects based on a defect-extracting method designated by the inspection condition information cc. The extracted defect-related information (position, area, and length of circumscribing rectangle on the inspection object substrate (Feret's diameter), etc.) output therefrom is extracted-defect information ff.

Feret's diameter indicates the total length of horizontal members and vertical members circumscribing a rectangle having the minimum size that circumscribes a focused object.

A defect-inspecting section 6 inspects the extracted defects. The defect-inspecting section 6 upon accepting the inspection condition information cc, the inspection image information ee, and the extracted-defect information ff undertakes classifying process to the extracted defects. The defect-inspecting section 6 in the classifying process produces predetermined classification results based on the defect information (position, area, Feret's diameter, and brightness, etc.) extracted by the defect-extracting section 5 in consideration of the existence and current states of other defects around the defect position and the importance of the defect on the inspection object substrate. In addition, the defect-inspecting section 6 has a function of quality checking with respect to a chip constituting the inspection object substrate. The quality check function is used in a modified example of the present embodiment which will be explained later.

The classifying process and the quality check with respect to chip make use of not only the extracted-defect information ff, but also information associated with the pattern and the contrast of brightness included in the inspection image information ee; and information associated with substrate design included in the inspection condition information cc, etc. The defect-inspecting section 6 upon obtaining the information outputs defect inspection analysis information gg including information associated with inspection object substrate.

A single-condition-inspection-result-producing section 7 produces inspection results based on the defect inspection analysis information gg under a singular condition which is one of the inspection conditions. The inspection result produced based on the singular condition according to the present embodiment will have a format sorted by a main key used in data integration in succeeding an inspection-result-integrating process, e.g., defect information (position on the substrate and area ratio on the corresponding chip) sorted by a key corresponding to the classification detail (more specifically, ID, etc. indicative of classification name); and defect information of a chip as a unit. The inspection results produced and output therefrom will become single-condition-inspection-result information hh.

The single-condition-inspection-result information hh put into an inspection-result-storage-controlling section 8 and subject to instruction provided by the control information aa becomes inspection result storage information jj which will be included and stored in an inspection result storage buffer 9. The inspection result storage information jj, substantially the same as the single-condition-inspection-result information hh, has additional information, e.g., inspection condition ID distinguished from the outcome based on another inspection condition which will be produced later.

Upon finishing processes including image-pickup control by the image-pickup section 3 and storing of the inspection result storage information jj, the control information aa for instructing the integrating process of the inspection result to the inspection-result-storage-controlling section 8 is put into the inspection apparatus 1. The inspection-result-storage-controlling section 8 upon accepting the instruction retrieves the inspection result storage information jj of each inspection condition stored in the inspection result storage buffer 9; and sends the retrieved inspection result storage information jj in one unit of information (inspection-result-information kk for integration use) to a substrate inspection-result-producing section 10.

The substrate inspection-result-producing section 10 integrates the inspection results associated with all the inspection conditions included in inspection-result-information kk for integration use in view of defect information (shape, size and classification detail, etc. of defect). More specifically, in a case where a plurality of inspection results indicate the existence of a defect in the same location of the inspection object substrate, the substrate inspection-result-producing section 10 refers to defect information in each inspection result; adapts information corresponding to a larger area (or adapts information corresponding to a narrower area); or obtains information by incorporating (i.e., integrating) logical ORs obtained based on each defect area. Alternatively, any fatal defect existing (in the classification details) in the same chip or in substantially the same position is subject to status NG based on the information. In addition, information having higher classification accuracy is used if there are a plurality of information indicating fatal defects.

The aforementioned substrate inspection-result-producing section 10 integrates inspection results so that a set of classification information is defined to one defect. The integrated inspection result relating to the inspection object substrate upon becoming substrate inspection-result information mm is output from the inspection apparatus 1 and submitted to other apparatus or a system undertaking integral control for a whole inspection procedure.

The present invention is not limited to the present embodiment wherein the substrate inspection-result information mm, which is a finalized inspection result, has one set of classification information corresponding to one defect. For example, a plurality of classification information may correspond to a defect (to be linked and stored) by weighting and combining the plurality of classification information based on the defect information or the classification information in a case where a plurality of sets of inspection results indicate that defects existing in a same area (chip) show different inspection results.

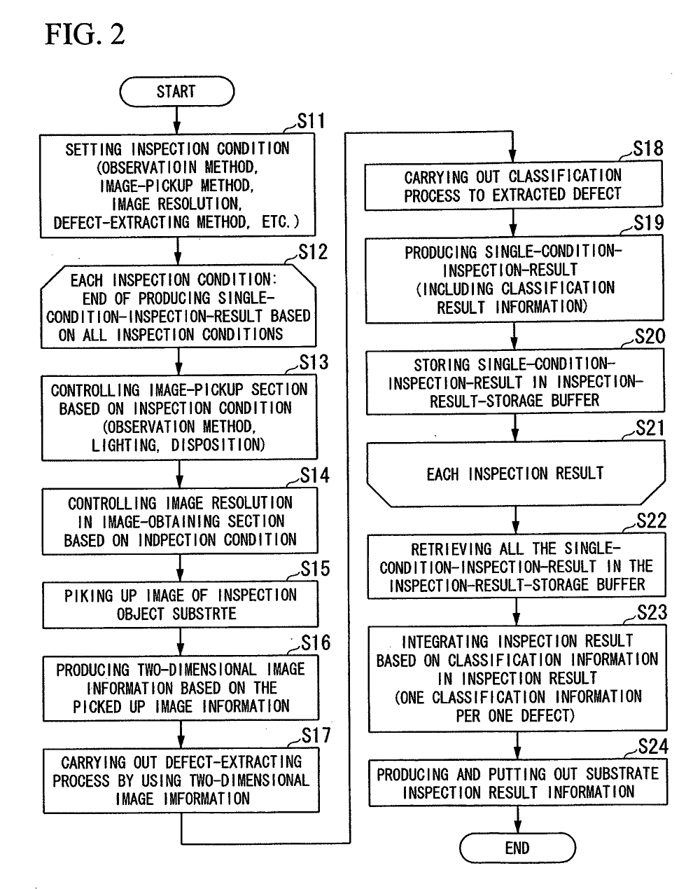

Operation of the inspection apparatus according to the present embodiment will be explained next. FIG. 2 shows a sequence of operations carried out by the inspection apparatus 1 illustrated in FIG. 1. More specifically, FIG. 2 shows a sequence of operations beginning with inspection starting immediately after a carriage stage accepts an inspection object substrate; and an ending with outputting inspection result immediately before taking out the substrate from the carriage stage.

To start with, an inspection-condition-setting section 2 sets (step S11) inspection conditions (observation method, image-pickup method, image resolution of inspection object substrate, and defect-extraction method, etc.). Subsequently, the process enters a loop process per inspection condition (step S12). The step S12 upon monitoring as to whether loop sequences following the step S12 are fulfilled, and upon recognizing the process carried out based on all the inspection conditions proceeds to a step next to the loop procedure end (step S21).

The image-pickup section 3 is controlled based on the inspection conditions in the loop process (step S13). More specifically, the controlled items are, observation method, lighting method and quantity of light, and correlation of disposing an image-pickup system and the inspection object substrate. Image resolution control is subsequently conducted as to determine the pixel size in the image-obtaining section 4 based on the inspection condition (step S14). Subsequently, the image-pickup section 3 picks up an image of the inspection object substrate (step S15), and the image-obtaining section 4 produces two-dimensional image information based on the image-pickup information (step S16).

The defect-extracting section 5 using the produced two-dimensional image information undertakes a defect-extracting process (step S17). The defect-inspecting section 6 undertakes a classifying process corresponding to the extracted defects (step S18). The single-condition-inspection-result-producing section 7 upon receiving the outcome of classifying process produces an inspection result under a single condition based on defect information including the classifying process (step S19). The inspection result under the single condition controlled by the inspection-result-storage-controlling section 8 is stored in the inspection result storage buffer 9 (step S20). The sequence upon undertaking the loop process of steps S13 to S20 reaches the loop end (step S21). The sequence upon reaching the loop end returns to the loop start (step S12) and determines as to whether or not all the inspection conditions have been undertaken.

Upon determining the end of the loop process (the inspection result storage buffer 9 stores the inspection result under single condition associated with all the inspection conditions), the inspection-result-storage-controlling section 8 retrieves all the inspection results under the single condition existing in the inspection result storage buffer 9 (step S22). The substrate inspection-result-producing section 10 integrates the retrieved inspection result under the single condition based on the classification information included in the inspection result (step S23). This allows one set of classification information to be defined with respect to defects. Finally, the inspection of the inspection object substrate ends upon outputting the substrate inspection-result information mm integrated from defect point of view from the substrate inspection-result-producing section 10 (step S24).

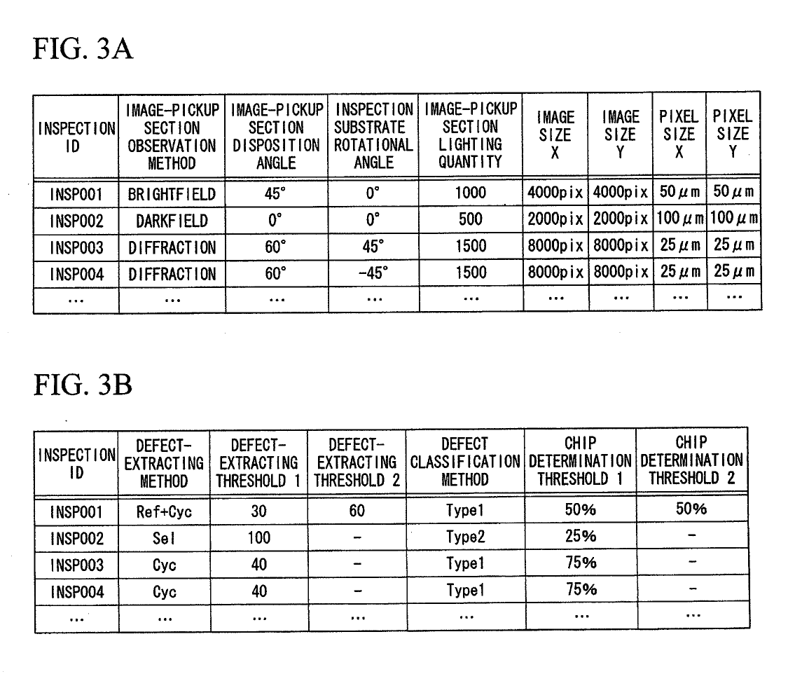

Details of inspection condition information will be explained next in the present embodiment. FIGS. 3A to 3D are lists of setting inspection condition information and inspected substrate information. FIGS. 3A and 3B provide information (including level-setting values or thresholds, etc.), for implementing functions of the image-pickup section 3, the image-obtaining section 4, the defect-extracting section 5, and the defect-inspecting section 6, sorted by a key inspection condition ID. In addition, inspected substrate information shown in FIGS. 3C and 3D sorted by a key substrate ID under inspection provide information, associated with substrate type of the inspection object substrate, steps, and designing of a substrate.

For example, the inspection condition information includes four sets of inspection condition. This indicates that an inspection object substrate undergoes four kinds of inspection conditions. The inspection condition information includes: an observation method of the image-pickup section 3 (brightfield observation, darkfield observation, or diffraction observation); an angle for disposing the image-pickup section 3 (angle defined by a line orthogonal to the (principal) plane of the inspection object substrate and the optical axis of an optical system of the image-pickup section 3); a rotational angle of the inspection object substrate in the plane of the substrate; a quantity of light emitted from the image-pickup section 3; the image size indicative of image resolution (horizontal (X) direction, vertical (Y) direction); image size similarly indicative of the image resolution (X-direction, Y-direction); a defect-extracting method employed by the defect-extracting section 5 (reference comparison: Ref, brightness distribution analysis: Sel, Cyclic pattern comparison: Cyc); the image brightness threshold for determining as to whether or not there is a defect in each defect-extracting process (a threshold for an extracted defect); method for classifying the extracted defects (identifying classifications into Type 1, Type 2, etc.); and the threshold for quality check per chip (ratio of area occupied by fatal defect (inferred based on the outcome of classification) in the whole chip area). Each component of the inspection apparatus 1 controlled based on the information is prepared for predetermined inspections.

One set of inspected substrate information is defined corresponding to an inspection object substrate. The inspected substrate information includes: product ID; process ID; lot ID including the inspection object substrate; substrate size (of corresponding wafer size); chip size disposed on the substrate (X-direction, Y-direction); number of wafer chips within pattern-exposing unit shots (X-direction, Y-direction); number of shots in a matrix indicative of correlation between shots to the wafer and chips (X-direction, Y-direction); width of scribe line (dicing line) existing between adjacent chips (X-direction, Y-direction); and width of edge cut (X-direction, Y-direction).

Edge cut indicates the resist-pattern-removed section of a wafer measured in radial direction.

In the present embodiment, the inspection condition information and the inspected substrate information as shown in FIGS. 3A to 3D become inspection condition information cc which is output to each component from the inspection-condition-setting section 2 every time each inspection is carried out based on the corresponding inspection condition. It should be noted that the inspection condition information cc output from the inspection-condition-setting section 2 may include information integrated associated with all the inspection condition; each component may store inspection order and necessary inspection condition corresponding to the inspection order; and each control component may retrieve the corresponding inspection condition sequentially based on inspection-start instructions provided by the control information aa.

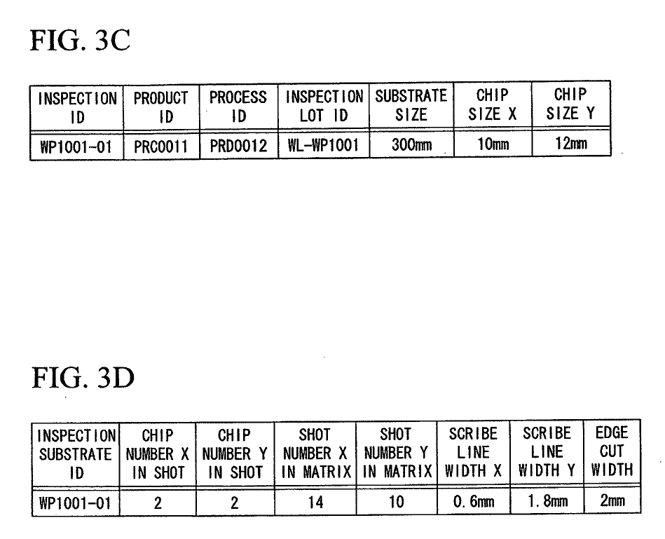

Configurations of the image-pickup section 3 and the image-obtaining section 4 will be explained next. FIG. 4 shows an architecture in the image-pickup section 3 and the image-obtaining section 4 according to the present embodiment. The image-pickup section 3 driving a light-illuminating system and an image-pickup sensor system separately is configured to pick up an image of light illuminated and reflected in various angles. In addition, the image-obtaining section 4 is configured to convert image-pickup information provided by the image-pickup section 3 to a two-dimensional image having a predetermined resolution upon eliminating shading and distortion imparted by the image-pickup section 3.

To start with, the control information aa and the inspection condition information cc are put into an image-pickup-system-controlling section 11. Information indicative of starting preparation for picking up an image output from the image-pickup-system-controlling section 11 accepting the control information aa and the inspection condition information cc are lighting-system-controlling information nn, image-pickup-sensor-control-information oo, and stage-control information pp.

The lighting-system-controlling information nn is sent to a lighting-system-controlling section 12. The lighting-system-controlling section 12 produces an angle of the light-illuminating system (angle of light illuminated onto the surface of the inspection object substrate) and lighting-system-driving information qq for controlling the quantity of the illuminated light based on the lighting-system-controlling information nn; and sends them to a lighting system 14. The lighting system 14 illuminates the inspection object substrate disposed on a stage 17 based on the angle of the light-illuminating system and the quantity of the illuminating light indicated by the lighting-system-driving information qq.

The image-pickup-sensor-control-information oo is sent to an image-pickup-sensor-controlling section 13. The image-pickup-sensor-controlling section 13 produces image-pickup-sensor-drive information rr based on the image-pickup-sensor-control-information oo for controlling the angle of the image-pickup system (angle for picking up image of the surface of the inspection object substrate); image-picking-up scope; and scan rate during image-pickup, etc., and sends them to an image-pickup sensor 15. The image-pickup sensor 15 built in the optical system (not shown in the drawing) picks up images of the inspection object substrate disposed on the stage 17 according to the angle of the image-picking-up system and the image-pickup scope indicated by the image-pickup-sensor-drive information rr.

The present embodiment using a line sensor-type image-pickup sensor 15 adapts a method for sequentially and periodically picking up image information put into the line sensor by driving the stage 17. Comparable capability can be maintained by adapting an image-pickup method using an area-sensor-type image-pickup device in place of the line-sensor type device and picking up an image of the inspection object substrate disposed on the stage 17 in one shot (without moving the stage 17).

The stage-control information pp is sent to a stage-controlling section 16. The stage-controlling section 16 produces stage-drive information ss based on the stage-control information pp for controlling stage-movement distance and driving speed while picking up images; driving direction; and rotational angle of the inspection object substrate with respect to the image-pickup sensor 15, and sends them to the stage 17. The stage 17 rotates, if necessary, the inspection object substrate in the plane which is parallel with the principal surface of the substrate based on the driving distance and driving speed indicated by the stage-drive information ss, and drives the inspection object substrate in a direction orthogonal to a line direction of the image-pickup sensor 15.

Image-pickup readiness information associated with the lighting-system-controlling section 12, the image-pickup-sensor-controlling section 13, and the stage-controlling section 16 converted to lighting-system-controlling information nn, image-pickup-sensor-control-information oo, and stage-control information pp are sent to the image-pickup-system-controlling section 11. The image-pickup-system-controlling section 11 upon accepting the information sends out control information to start image pickup, including the lighting-system-controlling information nn; the image-pickup-sensor-control-information oo; and the stage-control information pp, to the lighting-system-controlling section 12; the image-pickup-sensor-controlling section 13; and the stage-controlling section 16, to cause them to pick up images. Upon ending the pick up of the whole image of the inspection object substrate, the lighting-system-controlling section 12, the image-pickup-sensor-controlling section 13, and the stage-controlling section 16 respectively send out information, i.e., the lighting-system-controlling information nn, the image-pickup-sensor-control-information oo, and the stage-control information pp, which indicate the end of image pickup, to the image-pickup-system-controlling section 11; thus, the image-picking up operation ends.

Every line of image information, i.e., image-pickup information dd, picked up and obtained by the image-pickup sensor 15 is output from the image-pickup sensor 15 and put into a shading-compensation section 18 disposed in the image-obtaining section 4. The shading-compensation section 18 carries out a compensation process for equalizing non-uniform brightness associated with the optical system and the image-pickup sensor 15; and non-uniform brightness associated with the lighting system 14 and the light emitted therefrom.

The image-pickup information having undergone the shading compensation is sent to a distortion-compensation-processing section 19. The distortion-compensation-processing section 19 undertakes compensating geometric distortion in images caused by the optical system of the image-pickup sensor 15. The image-pickup information having undergoing distortion compensation of the distortion-compensation-processing section 19 is put into a resolution-controlling section 20. The resolution-controlling section 20 undertakes image resolution conversion (for example, a plurality of lines or pixels are converted) if necessary based on resolution instructed by the inspection condition information cc (identified from the image size and the pixel size specified in FIGS. 3A to 3D). The process carried out by the resolution-controlling section 20 will be explained later.

The image-pickup information having undergone the resolution conversion by the resolution-controlling section 20 is put into a two-dimensional-image-producing section 21. Two-dimensional image produced by synthesizing the image-pickup information of each line by the two-dimensional-image-producing section 21 becomes inspection image information ee and is output for image processing after defect extraction and beyond.

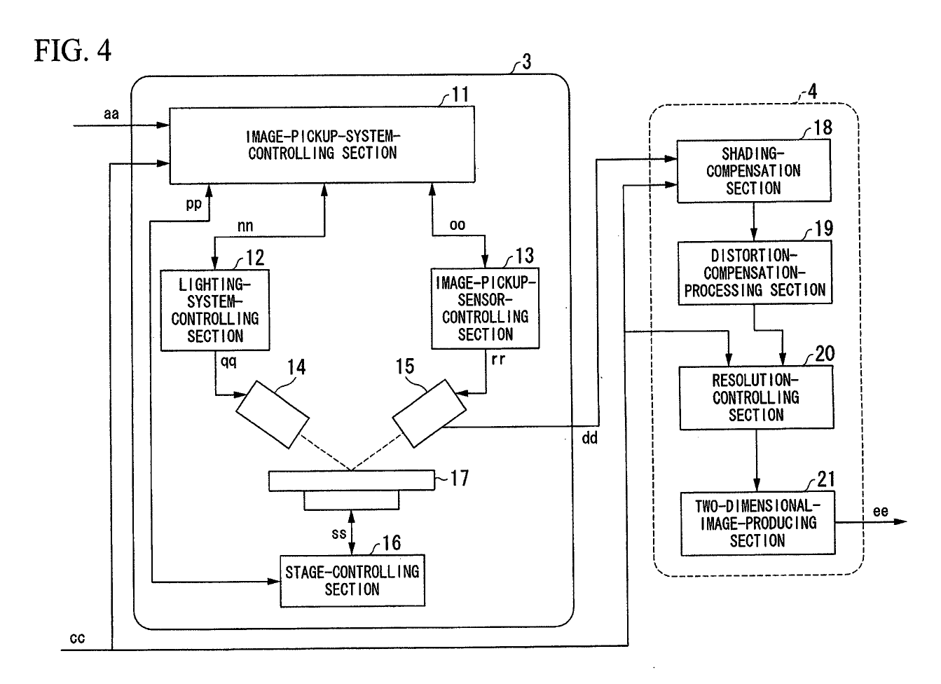

Details of inspection conditions set corresponding to the image-pickup section 3 and the image-obtaining section 4 will be explained next. FIGS. 5A to 5C show appearances of captured observation images of the inspection object substrate. FIGS. 5A to 5C show, in order from left, brightfield image 31a picked up based on brightfield observation; darkfield image 31b picked up based on darkfield observation; and diffracted image 31c picked up based on diffraction observation.

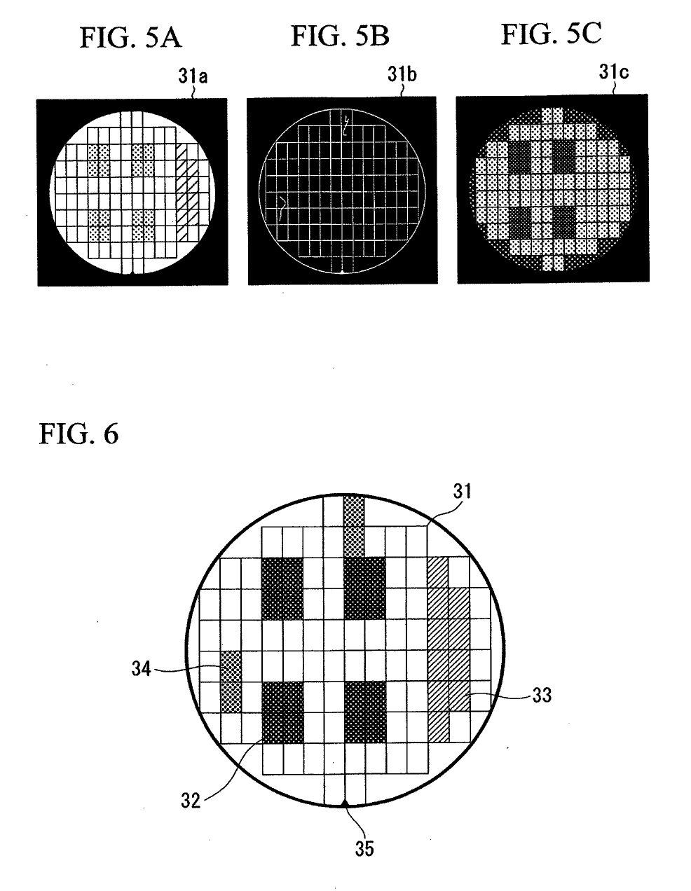

FIG. 6 shows how defects existing on the inspection object substrate appear. The drawing shows on which chip of the inspection object substrate 31a plural kinds of defects exist. The defects on the substrate 31 include true defect which is problematic in implementing production processes thereafter; shot-defocus 32; irregular etching 33, i.e., normal defect which will not affect production processes thereafter; and true defect, i.e., scratch 34. The substrate 31 is provided with a notch 35 at a lower end in the drawing for directivity recognition in pattern exposition.

Defects indicated by the shot-defocus 32, the irregular etching 33, and the scratch 34 may be classified into readily observable group or hardly observable group under various observation conditions. That is, recognizing such various types of defects necessitates obtaining images of various kinds under suitable observation conditions and inspecting them.

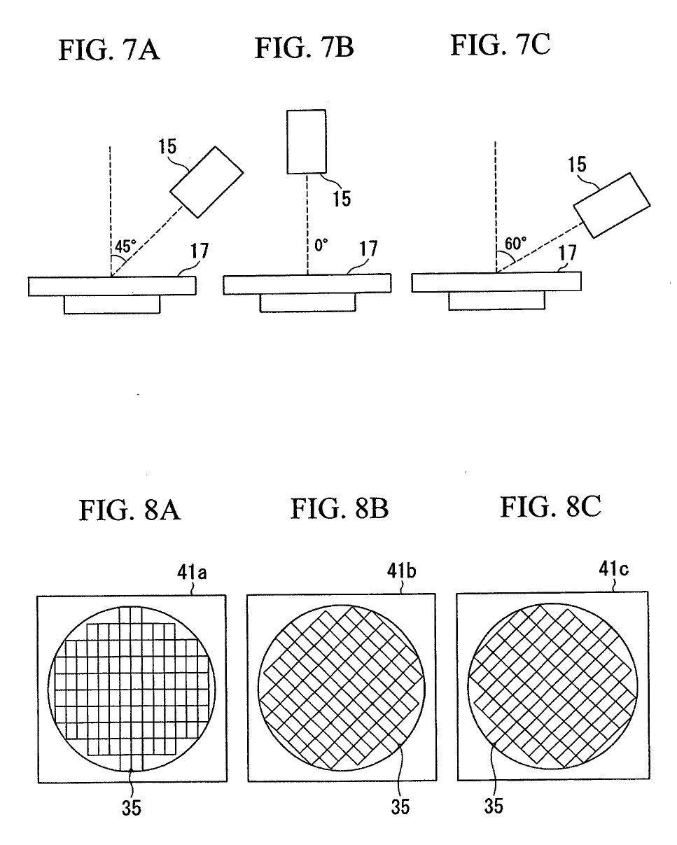

FIGS. 7A to 7C show correlations between the surface of the inspection object substrate and the image-pickup sensor 15 (relationship in angle defined by both components). More specifically, FIGS. 7A to 7C show the relationship, i.e., the angle defined by the optical axis of the image-pickup sensor 15 and the axis orthogonal to the plane of the stage 17. The correlation of both components based on the inspection condition shown in FIGS. 3A to 3D is configured to be different based on observation conditions.

A correlation based on inspection condition ID=INSP0001 (brightfield observation) as shown in FIG. 7A illustrates that an optical axis of the image-pickup sensor 15 inclines by 45 degrees with respect to a line orthogonal to the plane of the stage 17. A correlation based on inspection condition ID=INSP0002 (darkfield observation) as shown in FIG. 7B illustrates that the optical axis of the image-pickup sensor 15 coincides with the line orthogonal to the plane of the stage 17 (i.e., inclination angle is 0 degree). A correlation based on inspection conditions ID=INSP0003 and INSP0004 (both of which indicate diffraction observation) as shown in FIG. 7C illustrates that the optical axis of the image-pickup sensor 15 inclines by 60 degrees with respect to the line orthogonal to the plane of the stage 17.

The aforementioned angles in the present embodiment are mere examples since regular reflection or diffraction in the image-pickup sensor 15 looks different based on patterns formed on the inspection object substrate. The present embodiment is configured to permit observation of reflected light or diffracted light in various conditions by freely varying an angle defined by the image-pickup sensor 15 and the stage 17, or by varying an angle, if necessary, defined by the lighting system 14 and the stage 17.

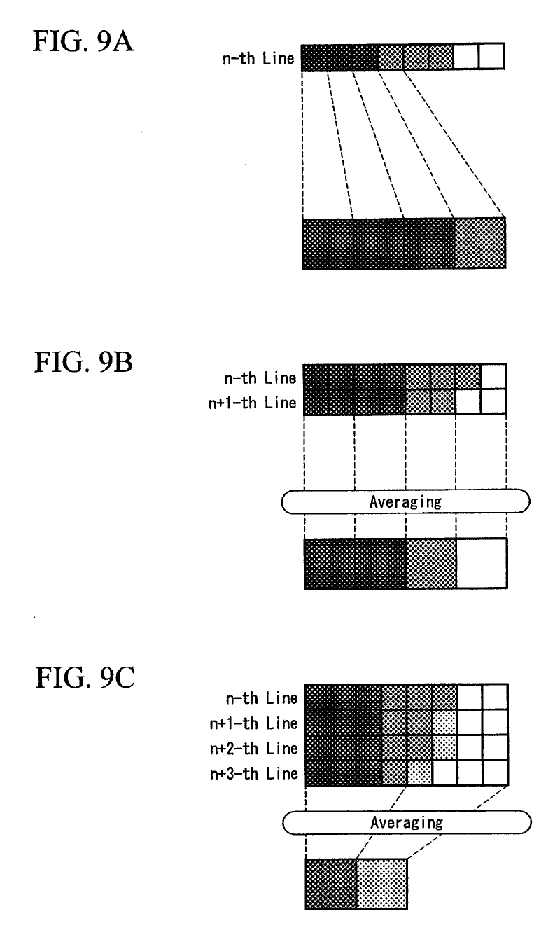

FIGS. 8A to 8C show various rotational angles of the inspection object substrate. These drawings correspond to inspection conditions shown in FIGS. 3A to 3D. FIG. 8A shows an image 41a having 0 (zero) degrees of rotational angle (the lower end of a circle where the notch 35 is located in the drawing indicates a reference point of the rotational angle); FIG. 8B shows an image 41b having a 45 degree rotational angle; and FIG. 8C shows an image 41c having a −45-degree rotational angle. The image 41a is picked up based on inspection condition ID=INSP0001 (brightfield observation) and based on inspection condition ID=INSP0002 (darkfield observation) as shown in FIGS. 3A to 3D. The image 41b is picked up based on inspection condition ID=INSP0003 (diffraction observation) as shown in FIGS. 3A to 3D. The image 41c is picked up based on inspection condition ID=INSP0004 (diffraction observation) as shown in FIGS. 3A to 3D.

In particular, the substrate 31 shown in the images 41b and 41c is intentionally rotated in order to dispose orthogonalized patterns in diagonal directions and receive a specific order of diffracted light emitted from the orthogonalized patterns formed on the substrate 31. This allows the differentiation of a defect section from a normal section, thereby facilitating defect extraction and inspection.

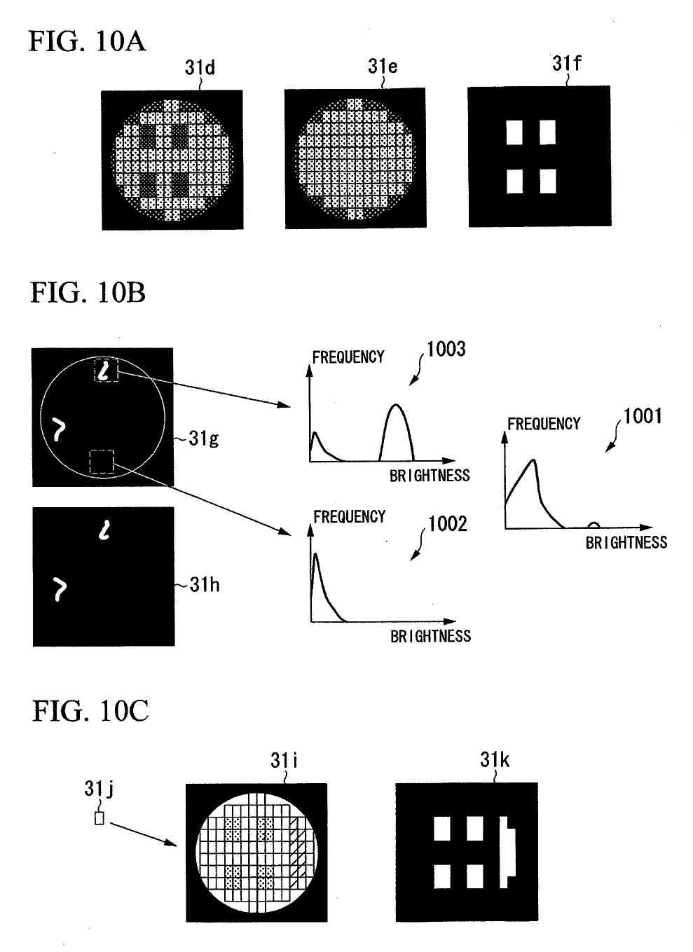

FIGS. 9A to 9C are examples of image resolution conversion carried out by the resolution-controlling section 20. In this configuration, a line sensor serving as the image-pickup sensor 15 forms a pixel from a plurality of lines or pixels. Resolution ratio is an index defined to indicate resolution. The resolution ratio, indicating the resolution of a post-conversion image relative to the resolution of an original image, has a maximum value of 1 (one) where the post-conversion resolution is the same as the resolution of the original image; and the resolution lowers as the resolution ratio decreases (i.e., having smaller image size and greater pixel size relative to a common object to be picked up). FIGS. 9A to 9C indicate the relationship between pixels of a line sensor and the corresponding post-resolution conversion pixel for three resolution ratios.

FIG. 9A shows a case of the resolution ratio indicating 1 where a non-converted state of the line sensor pixel becomes a two-dimensional image pixel. This case does not necessitate resolution conversion.

FIG. 9B shows a case of the resolution ratio indicating 1/2. This case utilizes two lines of image-pickup information produced by the line sensor; and further utilizes two adjacent pixels in the direction of pixels of the line sensor disposed in line. That is, a pixel is formed by two adjacent pixels disposed in a lateral direction (along the line sensor) and (two lines of) two adjacent pixels disposed in a vertical direction. To be more specific, four pixels are converted to a two-dimensional image pixel by conducting an averaging-process (i.e., averaging) to adjacent 2×2 pixels. Although resolution reduces in this state, smaller image size (number of pixels) enables faster inspection in no need of accuracy corresponding to the pixels of the line sensor.

FIG. 9C shows the case of the resolution ratio indicating 1/4. This case utilizes four lines of image-pickup information produced by the line sensor; and further utilizes four continuous pixels in the direction of the line sensor pixels disposed in line. That is, a pixel is formed by a pixel group formed by four adjacent pixels disposed in a lateral direction and four adjacent pixels disposed in a vertical direction. To be more specific, sixteen pixels in adjacent 4×4 format are averaged, i.e., converted to a two-dimensional image pixel. Although resolution in this state reduces more significantly than in the case of FIG. 9B, an image of 1/16 relative to the original image size enables faster inspection.

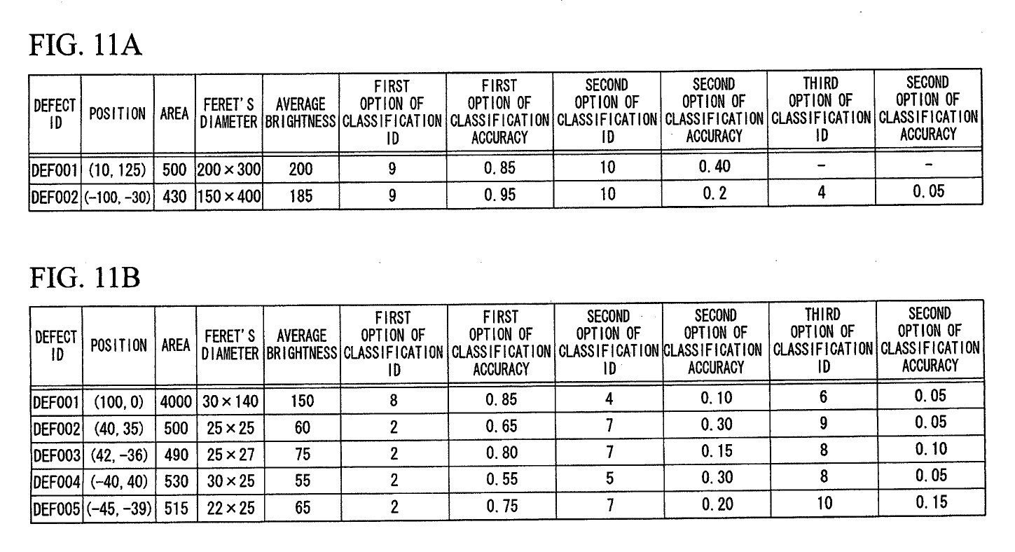

Details of a defect-extracting process carried out by the defect-extracting section 5 will be explained next. FIGS. 10A to 10C show how to extract a plurality of defects. Three kinds of defect-extracting methods prepared for the present embodiment are based on an idea contrived to make suitable selection among various methods based on the feature of the obtained image.

FIG. 10A corresponds to a defect-extracting method for extracting difference points based on a comparison between a reference image and an image undergoing inspection. FIG. 10A shows a case where the method is adapted to a diffracted image. A reference image 31e is prepared in advance which corresponds to image 31d, including the same type and production process as those of the reference image 31e, obtained by picking up the inspection object substrate using a diffracted image observation method. Then, comparison is made to both images to extract defects indicated by an area (pixel) having difference of which significance is equal to or greater than the preset inspection condition. This method can obtain a defect image 31f from the inspection image 31d and the reference image 31e.

This method can provide relatively easy defect extraction as long as image-positioning (matching) is conducted normally. Alternatively, the reference image 31e may not have to be a single piece of an image. For example, a reference image for use in defect extraction may be produced by using a plurality of reference images; taking variation in brightness among images into account; and averaging them. The use of a plurality of reference images can prevent pseudo-defects which may be obtained by extracting non-defective brightness variation erroneously.

FIG. 10B shows defect extraction method using brightness distribution of image of its own. FIG. 10B shows a case where the method is adapted to a darkfield image. To start with, an image 31g of the inspection object substrate is picked up by using darkfield observation, and then the brightness distribution of the image 31g of the substrate is obtained. In addition to brightness distribution associated with the whole substrate, brightness distribution in each localized area is obtained by dividing the whole substrate into several areas each having a predetermined size.

Subsequently the brightness distribution in each area is compared to the brightness distribution of the whole substrate. An area having a different inclination of distribution, which indicates a significant difference in brightness, is recognized as a defect to be extracted. A histogram is obtained based on the number of pixels corresponding to the current brightness, and inclination of distribution is analyzed by means of average, variance, mode brightness value, and peak brightness value, etc.

FIG. 10B shows brightness distribution 1001, associated with the whole image, having low average of brightness and having a peak value in a relatively low brightness section. The brightness distribution 1002 is a normal area indicating inclination identical to the brightness distribution of the whole image (having lower brightness value indicating a peak and lower average brightness). In contrast, brightness distribution 1003 indicating a defect area has a peak value in a relatively high brightness section and having relatively higher average brightness than that of the whole image.

This state of area (pixel) indicating a difference more significant than that of the brightness in the whole image is recognized as a defect to be extracted (greater than a threshold previously set in the inspection condition). This method obtains a defect image 31h from inspection image 31g. This method enables the extraction of a localized defect, e.g., a scratch in a case having uniform brightness with respect to the whole substrate and free from a specific pattern in an image.

FIG. 10C shows a defect extraction method using a periodical pattern in an image. FIG. 10C shows a case where the method is adapted to a brightfield image. The inspection image 31i obtained by picking up the inspection object substrate is compared to an image 31j having a periodical pattern by using brightfield observation based on presumption that a periodical pattern is formed on the inspection object substrate. An area (pixel) having difference equal to or greater than the level previously set in the inspection conditions is recognized as a defect to be extracted. This method obtains defect image 31k from an inspection image 31i.

The use of pattern periodicity in the substrate for defect recognition based on brightness having significant difference can negate the need for preparing a reference image corresponding to the whole substrate and suffice inspection with less information. The image 31j, in place of the image 31j having a periodical pattern prepared here, having a periodical pattern may be produced from the inspection image 31i of its own, or adjacent periodical patterns may be compared to each other without preparing the image 31j having a periodical pattern.

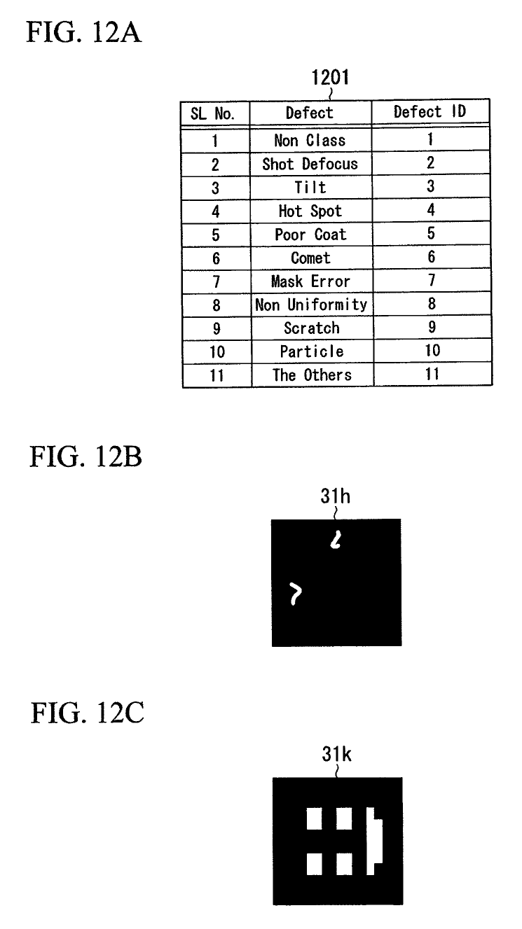

Details of defect classification information according to the present embodiment will be explained next. FIGS. 11A and 11B show examples of defect classification information produced by the defect-inspecting section 6. These are outcomes of the defect classification obtained by using the defect image 31h having undergone defect extraction as shown in FIGS. 10A to 10C; and the defect image 31k having undergone defect extraction using a periodical pattern obtained based on the brightfield image.

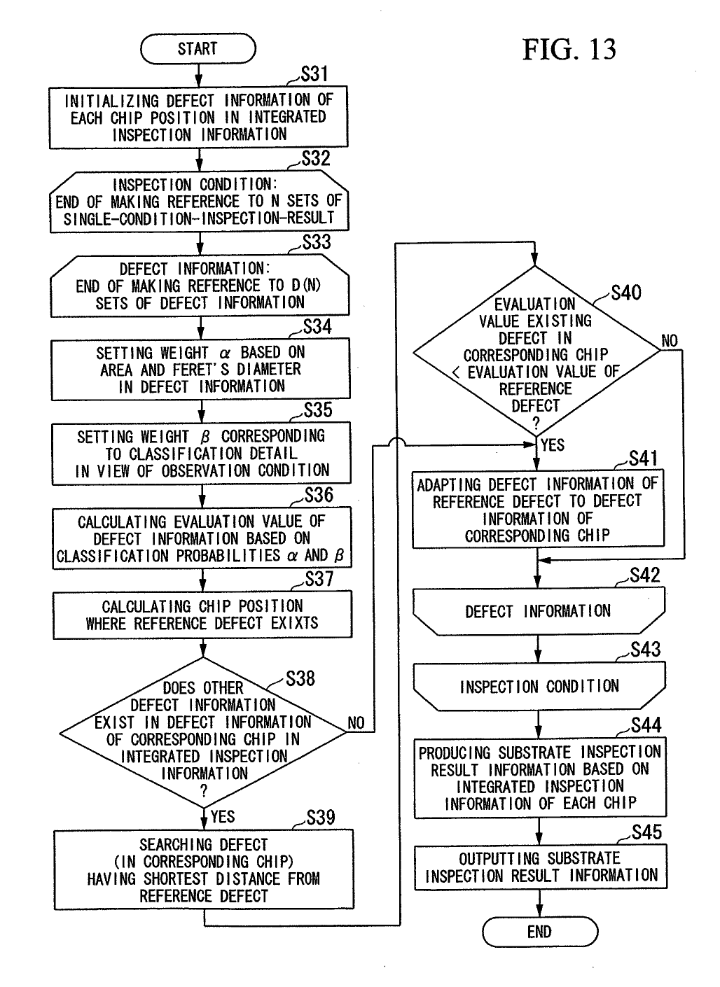

Table 1201 as shown in FIG. 12A shows a relationship between the classification name defined in the present embodiment and the ID for identifying the classification. Provided here are nine classification names (ID=2˜10); and eleven classifications indicated by “The Others” (indicated by ID=11 corresponding to a class irrelevant to the nine classifications) and “Non Class” (having ID=1 and irrelevant to classifying process).

The defect-classifying process is carried out by the defect-inspecting section 6 which has received the inspection condition information cc, the inspection image information ee, and the extracted-defect information ff. A method is adapted for making an analysis in detail with respect to the extracted defects area by using the inspection image information ee. The defect-classifying process according to the present embodiment includes: calculating “classification accuracy” indicative of the suitability of each rule based on a rule for specifying previously-stored classification details and defect feature quantity (including feature quantity calculated based on sections including not only the extracted-defect information ff but also the inspection image information ee); and adapting the classification corresponding to the rule which maximizes the classification accuracy.

For example, the classification accuracy indicates class “Scratch” (ID=9) in the TABLE 1201. The classification accuracy takes a numeral form of possibility (accuracy) where defect has a status of “Scratch” in a case using the area of defect and elongated narrow Feret's diameter (a length of diameter is longer than length of the other diameter). A smaller defect area and a narrower Feret's diameter increase the classification accuracy of being “Scratch”.

The classifying process is not limited to this method. For example, information disclosed by Japanese Unexamined Patent Application, First Publication No. 2003-168114 may be used which relates to a method using Fuzzy Inference and adapting classification rule for improving classification accuracy by eliminating previously-established classification species associated with defects from defect information. Specified classification detail is not limited to one set. A plurality of sets of classification detail may exist based on classification accuracy. It should be noted that the rule for specifying the classification detail can be updated (i.e., adding a new rule, correcting or deleting an existing rule) in view of inspection details and deterioration due to aging.

FIGS. 11A and 11B show classification information associated with defects observed in defect images 31h and 31k respectively. Defect feature quantity associated with each defect ID includes classification information indicated by a defect position (dimensions in mm) relative to a reference point defined as the center of a substrate; area (dimensions in mm²); Feret's diameter (dimensions in mm); and average brightness. In addition, classification information associated with classification includes classification IDs from a first option to a third option and their classification accuracy.

The classification options here are a first option, a second option, etc. indicated in order having significant classification accuracy calculated in the classifying process. In addition, a third option associated with classification accuracy is not necessarily calculated. The third option is not indicated in a case where the classification accuracy is lower than 0.05. Two “elongated” defects observed in the defect image 31h have a maximum classification accuracy indicating “Scratch”.

On the other hand, classification outcome associated with defects observed in the defect image 31k are different between maximum area defects (ID=DEF001: “non-uniformity”) and four other defects (ID=DEF002-DEF005: “Shot Defocus”). This does not limit items necessary for the classification information. Defect-related information may be added further. accuracy associated with all calculated classifications may be calculated with respect to the classifying process outcome.

The defect-inspecting section 6 according to the present embodiment is added to a function for setting defect classification details according to observation conditions and image resolution. For example, the defect-classifying process carried out in an inspection under inspection conditions set for obtaining a darkfield image is limited to a foreign body (“Particle”) or a scratch (“Scratch”) which can be extracted by the defect-extracting section 5 easily. Also, the defect-classifying process carried out in inspection under inspection conditions set for low image resolution is limited to non-uniformness (“non-uniformity”) or poor painting (“Poor Coat”) which can be extracted by the defect-extracting section 5 easily.

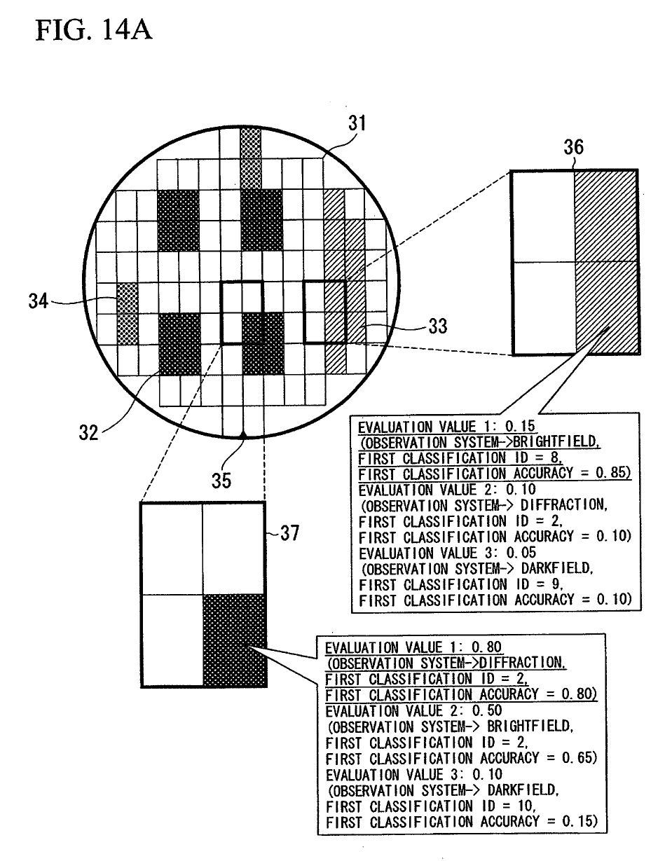

Details of the integrating process of the inspection result under a single condition carried out by the substrate inspection-result-producing section 10 will be explained next. FIG. 13 illustrates a procedure of the integrating process. The present embodiment in consideration of a chip being a minimum unit of quality check is configured to produce and output substrate inspection-result information, which is an outcome obtained by integrating defect information associated with an identical defect on each chip. In the present embodiment, an integer N indicates the number of an inspection condition; and an integer D(N) indicates the number of defects extracted based on each inspection condition.

To start with, defect information included in integrated inspection information which is intermediate information obtained in a process of producing the substrate inspection-result information is initialized with respect to a chip on an inspection object substrate (step S31). Subsequently, each inspection condition undergoes a loop process (step S32). The step S32 checks as to whether or not the following inspection condition loop process ends with respect to N sets of inspection conditions. The process upon recognizing the end of process in all the inspection conditions proceeds to a step next to an inspection condition loop procedure end (step S43).

The inspection condition loop process is carried out separately based on defect information obtained based on the inspection result under a single condition (step S33). The step S33 checks whether or not the following defect information loop process ends with respect to D(N) sets of defects extracted in inspection based on the corresponding inspection condition. The process upon recognizing the end of process conducted with respect to all the defects extracted in the corresponding inspection proceeds to a step next to the defect information loop procedure end (step S42)

Inspection condition/defect information loop process sets weight a based on area and Feret's diameter included in the defect-related information to which reference is made (step S34). The weight a is a parameter for use in the calculation, which will be conducted later, of the evaluation value of defect information. The weight α is under the control of information indicative of defect size, i.e., area and Feret's diameter. A larger defect area and a longer Feret's diameter increase the weight α.

For example, in a method for setting the weight α, an order for making reference to defect information in a defect information loop process may be in descending order with respect to a defect area; the weight a corresponding to defect information referred to first may be 1; and in the following steps, the weight a may be <1 based on the ratio of the defect information area or the Feret's diameter obtained in each reference order corresponding to the defect information area or the Feret's diameter which are referred to at first. This does not limit a method of setting the weight α. The defect information for specifying the weight α is not limited to the area or the Feret's diameter.

Subsequently, a weight β corresponding to the classification detail obtained by the defect-inspecting section 6 is set in consideration of observation condition (step S35). The weight β is a parameter for use in the calculation, which will be conducted later, of the evaluation value of defect information. The weight β is under control of importance (affection to the substrate) of observation condition and defect classification.

The weight β defined based on the aforementioned observation condition and classification detail has a maximum value of 1. The classification detail having greater importance in a predetermined observation condition obtains a greater weight β. For example, in the defect classification in the darkfield observation, a greater weight β is obtained with respect to “Scratch” or “Particle” since, in many cases, defect classification may indicate “Scratch” or “Particle” in FIGS. 12A to 12C; and, on the other hand, a greater weight β is obtained with respect to “Shot Defocus” or “Tilt” in a brightfield observation or diffraction observation than in those of the other cases.

Subsequently, evaluation value of defect information is calculated (step S36) based on the weight a set in the step S34, the weight β set in the step S35, and the classification accuracy of reference defect. The evaluation value of the defect information is calculated based on the following equation defined as (Eq-1). In the equation (Eq-1), “EvD(N, P)” indicates Pth evaluation value in Nth inspection condition; and “CAcc (N, P)” indicates the first option of classification accuracy which is used for reference in calculating the evaluation value.

EvD(N,P)=CAcc(N,P)×α×β (Eq-1)

The equation (Eq-a) provides the product of the weight α, the weight β, and the first option of classification accuracy CAcc (N, P). A greater evaluation value EvD (N, P), having a maximum value of 1, indicates more significant affection of reference defect on the inspection object substrate. In the evaluation value EvD (N, P), the weight a obtained based on an identical defect area and the Feret's diameter is a relative value which is variable per inspection since this factor indicates a ratio in the defect information. In contrast, the weight β obtained based on classification accuracy or classification detail is constant (absolute) regardless of the inspection. It should be noted that observation conditions may vary the weight β.

Accordingly, the evaluation value EvD (N, P) is defined to evaluate such a relative relationship and absolute relationship comprehensively. The formula for use in the calculation of the evaluation value EvD (N, P) is not limited to the equation (Eq-1). Another formula, as long as it is positioned as indicative of defect importance, may be used.

Subsequently, the chip position indicating where a defect currently being referred to exists is calculated (step S37), and as to whether or not information associated with another defect that already exists in the defect information corresponding to an applicable chip position is checked (step S38). The process proceeds to step S39 in a case where other defect information associated with the applicable chip position already exists. Otherwise the process proceeds to step S41.

In a case where other defect information already associated with the defect information of the applicable chip position exists, distance between (at least) defects existing in the applicable chip and defects which are currently being referred to is calculated (distance between defect centers respectively); and defects having a shortest distance are searched among the existing defects in the applicable chip (step S39). This is a step for determining that the shortest distance between defect centers indicates an identical defect based on the assumption that there is already an identical defect in defects inspected in different inspection conditions.

Subsequently, an evaluation value associated with defects already existing in the discovered applicable chip is compared to an evaluation value associated with the current reference defect calculated in the step S36 (step S40). The process proceeds to step S41 if the evaluation value of the already existing defect is smaller than the evaluation value of the current reference defect. Otherwise, the process proceeds to step S42.

When the evaluation value of the reference defect is greater than the evaluation value of the already existing defect in the step S40, or when defect information does not exist at the applicable chip position in the step S38, the defect information associated with the reference defect is adapted to the defect information of the applicable chip in the substrate inspection-result information (step S41). Adapted here is not only the evaluation value EvD (N, P) calculated in the step S36 but also defect information (position or area, etc.) associated with defects which are currently being referred to. Adaptation in this case indicates not “overwriting” previously-stored defect information but “additionally writing” thereonto. Therefore, a plurality of sets of defect information is maintained with respect to defects.

A loop sequence of steps S34 to S41 is conducted with respect to inspection condition/defect information, and the process reaches the defect information loop end (step S42). The process upon reaching to the defect information loop procedure end returns to defect information loop-starting point (step S33) and determines as to whether or not all the defect information based on the current inspection condition are processed.

When the loop procedure ends with respect to all the defect information based on the current inspection condition in the step S33, the process reaches the inspection condition loop procedure end (step S43). The process upon reaching the inspection condition loop procedure end returns to a inspection condition loop-starting point (step S32) and determines as to whether or not all the inspection conditions are processed.

Upon ending the loop procedure of the inspection condition (upon recognizing that all the defect information associated with all the inspection conditions are referred to), substrate inspection-result information is produced based on the integrated inspection information of each chip provided on the inspection object substrate (step S44) and output therefrom (step S45). Substrate inspection-result information adapted in the step S44 instantaneously is defect information having a maximum evaluation value calculated in the step S36 when a plurality of defect information are maintained with respect to, for example, a defect.

Otherwise, for example, defect information having not less than a predetermined threshold (0.5 relative to the maximum evaluation value of 1) of evaluation value calculated in step S36 and having the identical classification information (having the identical classification ID) is picked up, and substrate inspection-result information is obtained by adapting an average calculated associated with each information (area, etc.). One set of inspection results is produced with respect to defects by using the aforementioned method. This concludes the integrating process of the inspection result under a single condition.

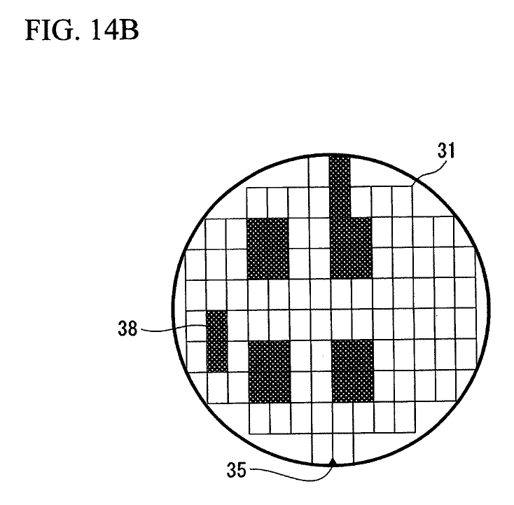

A specific example of integration of the inspection result will be explained next. FIGS. 14A and 14B show an example of integration of the inspection result associated with the inspection object substrate and associated with how to integrate defect information (inspection result) per chip. FIG. 14A shows an evaluation value obtained by focusing on a chip associated with areas 36 and 37 (areas including 2×2 chips) on the inspection object substrate 31 and made reference to during integrating the defect information. There are three kinds of evaluation values because defects are extracted from the chip based on various inspection conditions each having a different observation condition; classifying process with respect to the defect is carried out based on each inspection condition; and the evaluation values are calculated based on the outcome of the classifying process.

For example, the right-hand side of the area 36 includes defect, i.e., irregular etching 33, the defect observed in only brightfield image 31a as shown in FIGS. 5A to 5C and undergoing classifying process carried out by the defect-inspecting section 6 is classified into “non-uniformity” (ID=8). “Non-uniformity” defect is set to have relatively smaller weight β associated with the evaluation value calculation since significance of effect with respect to a defect of a substrate by a “non-uniformity” defect is relatively small in comparison with other defects, e.g., shot-defocus 32 or scratch 34. Therefore, the defect evaluation value is lowered even if the classification accuracy of “non-uniformity” is significant.

Based on the aforementioned analysis, each defect evaluation value 0.15 obtained based on the three kinds of inspection conditions (three kinds of observation conditions) is small even in a brightfield image which has the maximum thereof. This is because of the relatively small weight β of “non-uniformity” regardless of a relatively great classification accuracy 0.85. The evaluation value is still small in a case of lower classification accuracy with respect to classification outcome, which is considered important in the other inspection conditions. This reveals that the effect of a defect existing in the area 36 is less significant on the inspection object substrate.

On the other hand, the lower right chip of the area 37 includes defect, i.e., shot-defocus 32, this defect has been observed in the brightfield image 31a and the diffracted image 31c as shown in FIGS. 5A to 5C. The classifying process in the inspection based on each observation condition classifies the defect into “Shot Defocus” (ID=2). A greater defocus defect obtains a greater weight P associated with the calculation of the evaluation value. Defect evaluation values calculated with respect to the three kinds of inspection conditions based on the aforementioned analysis are: 0.80 in the diffracted image; 0.50 in the brightfield image; and 0.10 in the darkfield image. A relatively greater evaluation value not including the darkfield image reveals that the effect of defects in the area 37 is significant in the inspection object substrate.

The aforementioned defect information of the defect in each area (chip) is integrated based on the evaluation value. For example, defect information (area, etc.) or evaluation value is averaged which has identical classification details and not less than an evaluation value of 0.5. A “true defect” defined accordingly is further averaged to obtain defect information which indicates an inspection result.

As shown in FIG. 14B, chips (for example, chip 38) having a shot-defocus 32 or a scratch 34 thereon will be recognized as NG chips. The inspection result associated with the substrate 31 reveals that information explaining the reason for defect recognition will accompany the NG chip 38 (e.g., defect information or evaluation value).

As mentioned previously, the inspection apparatus according to the present embodiment upon weighting each inspection result of the inspection object substrate inspected based on a plurality of inspection conditions (steps S34 to S36 of FIG. 13) integrates the inspection result per inspection condition based on the defect information associated with defects on the substrate (steps S41 and S44 of FIG. 13) and produces a set of inspection results associated with the substrate. The inspection result obtained by integrating a plurality of inspection results negates the need for an operator to make references to a plurality of inspection results during a quality check associated with a substrate.

Clarified defect classification details allow an operator to conduct a quality check of a substrate in a case where a classification detail is linked with defects in the inspection results integrated in this manner. In contrast, an operator will be uncertain as to which classification detail he or she has to give priority when a plurality of classification details are linked with defects in the integrated inspection result. Possibly, in this case, the classification detail in view of the priority will be unclear.

To address this situation, for example, inspection results output together with the classification detail may be evaluation values. The evaluation value indicative of the priority of classification clarifies defect classification details. In an alternative configuration, the evaluation value itself may not be included in the integrated inspection result; and information indicative of the priority of classification (for example, order of evaluation value in size) together with the classification detail may be included. In any event, updating the integrated inspection result based on the outcome obtained by weighing the inspection result obtained based on each inspection condition enables maintaining clarity of defect classification details (that is priority of each inspection result).

This facilitates quality check of substrates, thereby discovering an abnormality of production apparatuses in the early stages. Furthermore, throughput of the whole production process can be enhanced.

Also, the substrate inspection-result-producing section 10 according to the present embodiment utilizing information associated with defect size (defect area or Feret's diameter) while integrating the inspection result weighs the inspection result based on the defect size. This obtains the following effects. For example, when fatal defect occurs in an inspection based on a predetermined inspection condition, and each inspection result obtained per inspection condition is integrated, the information associated with the fatal defect may be overwritten by non-fatal defect information having occurred in the inspection conducted based on another inspection condition. However, the configuration for obtaining the inspection result weighed more significantly (in view of priority) and integrating each inspection result improves the situation in which the information associated with the fatal defect may be “overwritten”, thereby producing a more accurate inspection result.

Also, the defect-inspecting section 6 according to the present embodiment performs classification of defects extracted by the defect-extracting section 5 and produces classification results. This enables clarification of defect type, thereby facilitating abnormality detection in production process.

Also, the substrate inspection-result-producing section 10 according to the present embodiment utilizing a defect classification outcome obtained when the inspection results are integrated weighs the inspection result based on the defect classification outcome. This obtains the following effects. A different priority of the classification outcome can be obtained based on details of the inspection conditions and the conditions of the inspection object substrate even if the classification outcomes are identical in the inspection results obtained based on a single condition. Therefore, in a case similar to the aforementioned case where a fatal defect occurs in an inspection based on a predetermined inspection condition, and the inspection results each obtained per inspection condition are integrated, possibly the information associated with the fatal defect may be overwritten by non-fatal defect information having occurred in an inspection conducted based on other inspection conditions. However, integrating inspection results weighed based on the classification outcomes improve the situation where the information associated with the fatal defect may be “overwritten”, thereby producing a more accurate inspection result.

Also, the classification outcome according to the present embodiment includes a classification name; and a probability (classification accuracy) which indicates that extracted defects relate to the classification name. Not limiting the classification outcome to a class, but proposing a plurality of combinations of classification names and probabilities indicating that a defect relates to a classification name can indicate the inspection result viewed from an objective standpoint. Also, the substrate inspection-result-producing section 10 can integrate the inspection results based on each inspection condition accurately.

In addition, the image-pickup section 3, the image-obtaining section 4, the defect-extracting section 5, and the defect-inspecting section 6 according to the present embodiment are configured to vary conditions thereof based on inspection conditions. Varying image-pickup conditions or image-obtaining conditions and the defect-analysis method based on the inspection details can provide a wide variety of inspections. Specifically, an inspection optimized in view of the details of the defect under inspection can be carried out.

For example, changing the observation conditions based on the inspection conditions and controlling the observation angle of an image-pickup system and the rotation angle of an inspection object substrate can obtain more accurate defect-related information, thereby providing an optimized inspection.

Also, changing the image resolution based on the inspection conditions (for example, lowering resolution in an inspection for observing a large area of defect (increasing the pixel size of an image obtained by picking up a inspection object substrate)) can provide a high speed inspection while reliability maintaining of the accuracy of inspection.

Also, the details of an inspection may vary based on observation conditions and the image resolution. In this configuration, setting the classification details of a defect based on observation conditions and the image resolution can cause the defect-inspecting section 6 to conduct an effective classifying process.

Also, comparing reference images of a substrate having identical properties (species, process, etc.) with those of a inspection object substrate free from defects to an image of an inspection object substrate, extracting differences, and extracting defects can facilitate the defect extraction performed by the defect-extracting section 5. In addition, when a comparison using the reference image is difficult (patterns do not exist on the inspection object substrate), making a comparison of different positions on an image, extracting differences, and extracting defects based on the assumption that the inspection object substrate has a uniform brightness distribution facilitates defect extraction.

Also, when periodic patterns are formed on the inspection object substrate, defect extraction utilizing the periodic patterns to extract areas losing periodicity can facilitate defect extraction.

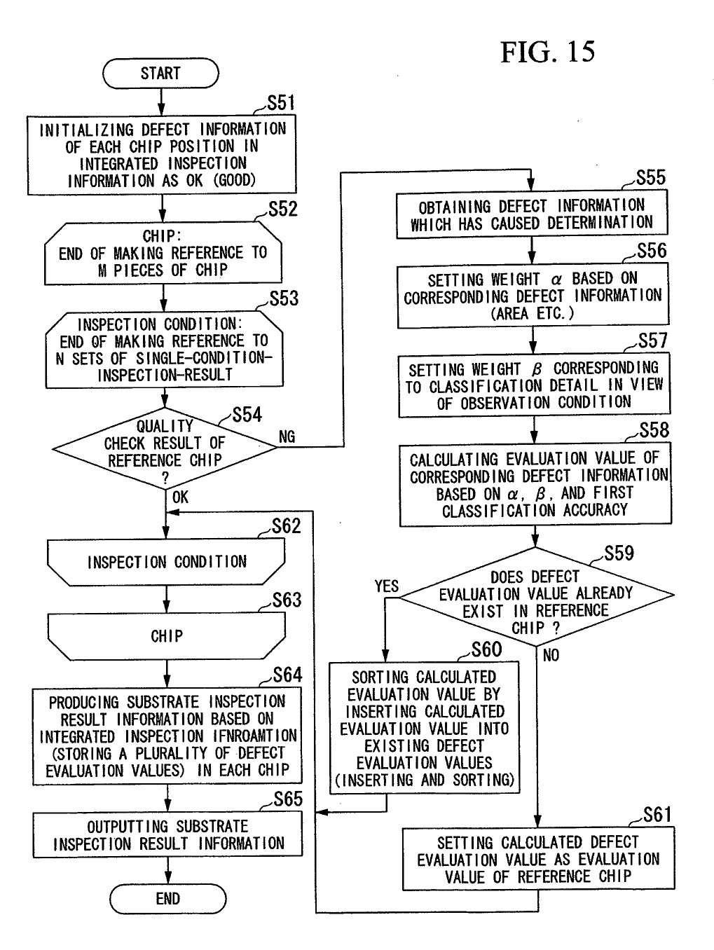

A modified example will be explained in which details in the process conducted by the substrate inspection-result-producing section 10 are modified in the present embodiment. FIG. 15 shows the procedure of the integrating process of an inspection result under a single condition carried out by the substrate inspection-result-producing section 10. The present modified example based on the assumption that the defect-inspecting section 6 produces a quality check for each chip integrates the inspection results in view of as to how the quality check outcome associated with a reference chip is obtained from the inspection results, sorted by using a key indicating the substrate chip, under a single condition based on each inspection condition, and how to recognize an abnormality in defect information in the case of a defect. The present modified example is beneficial when many defects are extracted and the defects are classified because the process speed is overwhelmingly high relative to a method making a reference to each defect.

Explained later are steps which will be conducted differently from those previously explained with reference to FIG. 13. In the present modified example, an integer N indicates the number of an inspection condition, and an integer M indicates the number of the chip provided on an inspection object substrate which will be an object of inspection.

To start with, defect information, associated with the chip provided on the substrate which is an object of inspection, included in integrated inspection information which is intermediate information obtained in a process of producing the substrate inspection-result information is initialized to have a status of “OK” (good) (step S51). Subsequently, the process undergoes a loop process per chip (step S52). The step S52 checks as to whether or not the following chip loop process ends with respect to M sets of chips. The process upon recognizing the end of process in all M sets of processes proceeds to a step next to a loop procedure end (step S63).

The process upon entering the chip loop process enters a loop process per inspection condition (step S53). This is identical to the step S32 of FIG. 13, and the inspection condition loop procedure end (step S62) is identical to the step S43 of FIG. 13. A quality check outcome obtained corresponding to a reference chip and based on reference inspection conditions is checked in a chip/inspection condition loop process succeeding the step S53 (step S54). The process proceeds to step S62 if the quality check outcome indicates “OK” (good), and the process proceeds to step S55 if the quality check outcome indicates “NG” (no good).

If the quality check outcome obtained based on the chip made reference to and under the inspection condition indicates “NG”, the process obtains defect information associated with a root cause of the NG status (step S55). An NG status is caused by a fact that feature quantity of defect itself, e.g., the defect area is equal to or greater than a threshold set associated with the NG status, or that classification outcome indicates fatal defect species. Defect information of a defect relating such conditions is obtained. When a plurality of defects which cause an NG status exist, defect information associated with the largest defect (e.g., defect having the largest defect area, or defect having maximum classification accuracy in fatal classification detail) is obtained.

Subsequently, the weight α is set for calculating an evaluation value associated with obtained applicable defect information (step S56), and the weight β is set corresponding to the classification detail obtained by the defect-inspecting section 6 in consideration of observation conditions (step S57). Subsequently, the evaluation value of defect information is calculated (step S58) based on the weight α, the weight β, and the first classification accuracy in the applicable defect. These steps are identical to the steps S34 to S36 of FIG. 13.

After the evaluation value of defect information is calculated in the step S58, as to whether or not an evaluation value already exists in the defect information in the integrated inspection information corresponding to the chip which is currently made reference to (step S59) is checked. The process proceeds to step S60 if the evaluation value of defect information exists. The process proceeds to step S61 if the evaluation value of defect information does not exist.

A process carried out when the evaluation value of defect information exists in the chip which is currently made reference to is an insertion and sort wherein the evaluation value of defect information calculated in the step S58 is inserted into a previously existing evaluation value which is concomitant with a reference chip and the evaluation values are sorted (step S60). The insertion and sort is a method of inserting new data into data previously sorted in a predetermined order and further sorting them to obtain updated data. This maintains a relationship having priority in size and satisfying a plurality of evaluation values even if a new evaluation value is inserted.

On the other hand, what is recognized as an evaluation value of a chip which is currently made reference to and is set anew (step S61) when the evaluation value of defect information does not exist in the chip which is currently made reference to is the evaluation value of defect information calculated in the step S58. If evaluation value which is different from that of the previous evaluation value is calculated in the succeeding process, the process of step S60 is carried out.

A loop sequence of steps S54 to S61 is conducted with respect to the chip/inspection condition, and the process reaches the inspection condition loop procedure end (step S62). The step S62 is identical to the step S43 of FIG. 13. The process upon recognizing the end of loop process based on N sets of inspection conditions reaches the chip loop procedure end (step S63). The process upon reaching the chip loop end returns to the chip loop-starting-point (step S52), and it is determined as to whether or not the process associated with M pieces of chip has been carried out.

Upon recognizing the end of the chip loop process (the end of making reference to M pieces of chip×N pieces of inspection condition), the substrate inspection-result information is produced (step S64) and output (step S65) based on the integrated inspection information sorted by using a plurality of key evaluation values of the defect information stored associated with each chip. The substrate inspection-result information includes not only the evaluation value of defect information but also defect information itself, e.g., the feature quantity accompanying the corresponding defect. This concludes the integrating process of the inspection result under a single condition.

Unlike the inspection result produced for each defect according to the process of FIG. 13, the inspection result output in the present modified examples is defect-related information which has caused the defect determined for each chip. Therefore, the defect-inspecting section 6 upon carrying out the chip quality check can undertake a high speed integrating process and review the chip quality check easily.

The embodiments of the present invention have been explained above in details with reference to the drawings. However, it should be understood that the drawings and detailed description thereto are not intended to limit the invention to the particular form disclosed; thus, the invention disclosed herein is susceptible to various modifications and alternative forms, i.e., design changes.

1. A defect-inspecting apparatus for inspecting defects on an inspection object based on a plurality of inspection conditions, the apparatus comprising:
an image-pickup unit for picking up an image of the inspection object and producing image-pickup information;
an image-producing unit for producing an image of the inspection object based on the image-pickup information;
a defect-extracting unit using the produced image for extracting the defects on the inspection object;
a defect-inspecting unit for inspecting the extracted defects and producing inspection results each corresponding to at least one of the plurality of the inspection conditions; and
an inspection-result-integrating unit for weighing the inspection results obtained based on the defect-related information and each inspection condition and integrating the inspection results obtained based on the inspection conditions.

2. The defect-inspecting apparatus according to claim 1, wherein the inspection-result-integrating unit for using the defect-related information indicative of the size of a defect and weighing the inspection results each corresponding to the inspection conditions based on the size of the defect.

3. The defect-inspecting apparatus according to claim 1, wherein the defect-inspecting unit further classifies the extracted defects and produces classification outcomes.

4. The defect-inspecting apparatus according to claim 3, wherein the inspection-result-integrating unit for using the classification outcomes indicative of the defect-related information and weighing the inspection results each corresponding to the inspection conditions based on the classification outcomes.

5. The defect-inspecting apparatus according to claim 3, wherein the classification outcomes include a classification name and a accuracy which indicates that the extracted-defect relates to the classification name.

6. The defect-inspecting apparatus according to claim 1, wherein at least one of the image-pickup unit, the image-producing unit, the defect-extracting unit, and the defect-inspecting unit varies each setting based on the inspection conditions.

7. The defect-inspecting apparatus according to claim 1, wherein the image-pickup unit further selects one of a brightfield observation, a darkfield observation, and a diffraction observation based on the inspection conditions; varies at least one of an angle defined by a line orthogonal to a plane of the inspection object and an optical axis of an optical system of the image-pickup unit and a rotational angle of the inspection object in the plane; and picks up an image of the inspection object.

8. The defect-inspecting apparatus according to claim 3, wherein the defect-inspecting unit sets classification detail of the defects based on an observation condition selected by the image-pickup unit.

9. The defect-inspecting apparatus according to claim 1, wherein the image-producing unit varies the resolution of the image based on the inspection conditions.

10. The defect-inspecting apparatus according to claim 3, wherein the defect-inspecting unit sets a classification detail of the defects based on the resolution of the image.

11. The defect-inspecting apparatus according to claim 1, wherein the defect-extracting unit extracts the defects by comparing a reference image associated with the inspection object to the image and extracting differences.

12. The defect-inspecting apparatus according to claim 1, wherein the defect-extracting unit extracts the defects by comparing the brightness distribution of the whole surface of the inspection object to the brightness distribution of a part of the surface of the inspection object and extracting differences.

13. The defect-inspecting apparatus according to claim 1, wherein the defect-extracting unit using periodic patterns formed on the inspection object extracts the defects.

14. A defect-inspecting method for inspecting defects on an inspection object based on a plurality of inspection conditions, the method comprising:
picking up an image of the inspection object and producing image-pickup information;
producing an image of the inspection object based on the image-pickup information;
using the produced image and extracting the defects on the inspection object;
inspecting the extracted defects and producing inspection results each corresponding to the inspection conditions; and
weighing the inspection result obtained based on the defect-related information and each inspection condition and integrating the inspection results obtained based on the inspection conditions.
